(19) United States
(12) Patent Application Publication
(10) Pub. No.: US 2026/0018784 A1
(43) Pub. Date: Jan. 15, 2026

(54) CLOSED-LOOP ANTENNA IMPEDANCE TUNING SYSTEM AND DRIVING

(71) Applicant: SAMSUNG ELECTRONICS CO., LTD., SUWON-SI (KR)

(72) Inventors: Sumin Kim, Suwon-si (KR); Min-Gi Kim, Suwon-si (KR); Sangmi Noh, Suwon-si (KR)

(21) Appl. No.: 19/063,952

(22) Filed: Feb. 26, 2025

(30) Foreign Application Priority Data
Jul. 12, 2024 (KR) 10-2024-0092417

(51) Int. Cl. H01Q 1/50

(52) U.S. Cl. CPC H01Q 1/50

(57) ABSTRACT

An impedance tuning system may include an antenna, a bi-directional coupler that transfers an input transmit path signal to the antenna, a feedback receiver configured to generate an input reflection coefficient based on a coupled signal received from the bi-directional coupler, an antenna impedance tuner circuit connected between the antenna and the bi-directional coupler, and including a plurality of stages, and a tuner control circuit configured to determine an optimal tune code based on a circuit characteristic value, which is calculated based on an impedance value of a passive element included in each of the plurality of stages and the input reflection coefficient, and control the antenna impedance tuner circuit based on the optimal tune code.

### CROSS-REFERENCE TO RELATED APPLICATION

This application claims priority to and the benefit of Korean Patent Application No. 10-2024-0092417 filed in the Korean Intellectual Property Office on Jul. 12, 2024, the entire contents of which is incorporated by reference herein.

### TECHNICAL FIELD

The present disclosure relates to a closed-loop antenna impedance tuning system and a driving method thereof.

### DISCUSSION OF RELATED ART

In the case of a wireless antenna transmission system, impedance mismatch causes power reflection from the antenna, resulting in loss of power delivered to the antenna, which reduces overall transmission efficiency. Accordingly, impedance tuning to minimize impedance mismatch loss plays an important role in wireless devices with a limited power supply. Impedance tuning may involve constructing a matching network (or tuner) by appropriately adjusting components such as switches, capacitors, and inductors.

There may be various methods for tuning impedance. For example, the electronic device may measure the I/Q (in-phase/quadrature-phase) value of the reflected signal and tune the antenna impedance based on the measured value. The antenna impedance tuning based on reflection coefficient values measured in real time is called closed-loop antenna impedance tuning (CL-AIT).

### SUMMARY

The present disclosure attempts to provide a closed-loop antenna impedance tuning system and a driving method of a closed-loop antenna impedance tuning system capable of optimizing antenna performance.

The present disclosure also attempts to provide a method for modeling an antenna impedance tuner circuit required for a closed-loop antenna impedance tuning system.

An impedance tuning system may include an antenna, a bi-directional coupler that transfers an input transmit path signal to the antenna, a feedback receiver configured to generate an input reflection coefficient based on a coupled signal received from the bi-directional coupler, an antenna impedance tuner circuit connected between the antenna and the bi-directional coupler, and including a plurality of stages, and a tuner control circuit configured to determine an optimal tune code based on a circuit characteristic value, which is calculated based on an impedance value of a passive element included in each of the plurality of stages and the input reflection coefficient, and control the antenna impedance tuner circuit based on the optimal tune code.

A driving method of an impedance tuning system may include receiving an input reflection coefficient generated based on a coupled signal received from a bi-directional coupler, calculating an output reflection coefficient with respect to an antenna based on a circuit characteristic value which is calculated based on an impedance value of a passive element included in each of a plurality of stages of an antenna impedance tuner circuit connected between the bi-directional coupler and the antenna, and the input reflection coefficient, determining an optimal tune code to correspond to the output reflection coefficient and the input reflection coefficient, and controlling the antenna impedance tuner circuit based on the optimal tune code.

A driving method of an impedance tuning system may include dividing an antenna impedance tuner circuit connected between an antenna and a bi-directional coupler into a plurality of stages, obtaining antenna impedance tuning (AIT) data indicating characteristics with respect to each of the plurality of stages, calculating a circuit characteristic value based on an impedance value of a passive element of the AIT data included in each of the plurality of stages, and storing the circuit characteristic value for use in real time impedance tuning of the antenna impedance tuner circuit.

### BRIEF DESCRIPTION OF THE DRAWINGS

FIG. 1 is a block diagram showing a CL-AIT system according to an embodiment.

FIG. 2 is a block diagram showing a configuration of a tuner control circuit according to an embodiment.

FIG. 3 is a flowchart showing an operation of a tuner control circuit according to an embodiment.

FIG. 4 is a drawing showing an exemplary antenna impedance tuner circuit.

FIG. 5 is a drawing showing the case of grouping the antenna impedance tuner circuit according to FIG. 4 into a plurality of stages.

FIG. 6 is a drawing showing AIT data of the antenna impedance tuner circuit according to FIG. 4.

FIG. 7 is a drawing showing the case of modeling the antenna impedance tuner circuit according to FIG. 4.

FIG. 8 is a flowchart specifically showing the calculating of the circuit characteristic value according to FIG. 3.

FIG. 9 is a drawing showing the case where a target stage is a series type.

FIG. 10 is a drawing showing the case where a target stage is a shunt type.

FIG. 11 is a flowchart showing an operation of an optimal tune code determination module according to an embodiment.

FIG. 12 is a graph showing a measured transmitted power according to an antenna impedance in a low-frequency band.

FIG. 13 is a graph showing a measured transmitted power according to an antenna impedance in a mid-frequency band.

FIG. 14 is a graph showing a measured transmitted power according to an antenna impedance in a high-frequency band.

FIG. 15 is a block diagram of an electronic device according to an embodiment.

### DETAILED DESCRIPTION OF EMBODIMENTS

In the following detailed description, only certain embodiments of the present disclosure have been shown and described, simply by way of illustration. As those skilled in the art would realize, the described embodiments may be modified in various different ways, all without departing from the spirit or scope of the present disclosure.

Accordingly, the drawings and description are to be regarded as illustrative in nature and not restrictive. Like reference numerals designate like elements throughout the specification. In the flowchart described with reference to the drawings, the operation order may be changed, several operations may be merged, certain operations may be divided, and particular operations may not be performed.

In addition, expressions written in the singular may be construed in the singular or plural unless an explicit expression such as “one” or “single” is used. Terms including ordinal numbers such as first, second, and the like will be used only to describe various components, and are not to be interpreted as limiting these components. These terms may be used for the purpose of distinguishing one component from other components.

Herein, components described with numerical-based labels do not necessarily mean that the associated embodiment includes the stated number of components. For example, an embodiment with “a twenty-second switch SW22” does not necessarily mean that 22 or more switches are included in the embodiment.

In embodiments of the inventive concept described below, the structure of an AIT chip may be taken as input in advance, such that an antenna impedance tuner circuit is modeled by partitioning it into multiple stages, where each of the stages includes a transmission line. Each of the stages may further include one or more passive elements (e.g., an inductor(s) and/or a capacitor(s)) and one or more bypass switches to bypass the passive element(s). Each stage may compensate for the effects of small losses and phase delays caused by short transmission lines (among the transmission lines). Using the characteristics of the passive elements and transmission line for each stage, S-parameters for an entire candidate tune code may be calculated. In this regard, tuning of the antenna tuning circuit becomes possible in less time (e.g., real time tuning is possible), and less memory is used for input impedance as compared to conventional systems.

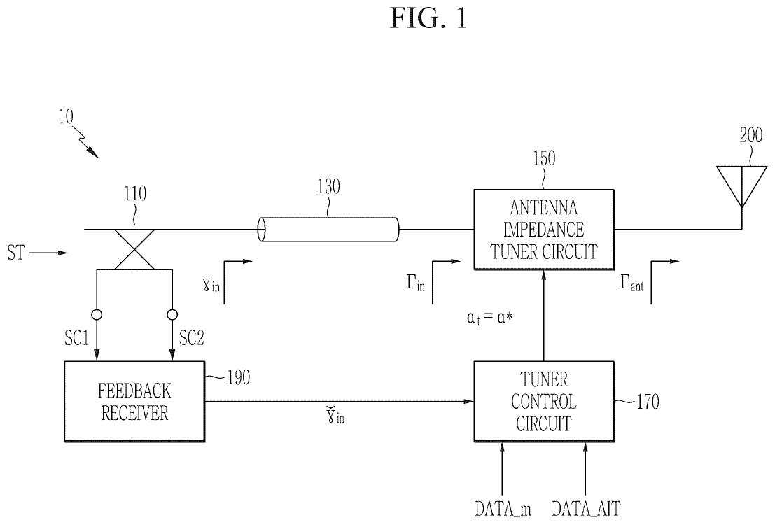

FIG. 1 is a block diagram showing a CL-AIT system according to an embodiment.

A CL-AIT system 10 may include an antenna 200, an antenna impedance tuner circuit 150, a tuner control circuit 170, a feedback receiver 190, a bi-directional coupler 110, and a radio frequency (RF) printed circuit board (PCB) 130 connecting the bi-directional coupler 110 and the antenna impedance tuner circuit 150.

The bi-directional coupler 110 may be coupled to a signal line between a power amplifier (not shown) and the antenna impedance tuner circuit 150, to couple a reflected signal of a transmission signal to a feedback path.

The CL-AIT system 10 may receive signals through the bi-directional coupler 110. The bi-directional coupler 110 may perform a coupling operation with respect to the reflected signal, and output it to the antenna impedance tuner circuit 150 through an RF PCB or other transmission line 130. The signal having passed through the antenna impedance tuner circuit 150 may be transmitted to free space through the antenna 200. Accordingly, the bi-directional coupler 110 may receive an input transmit path signal S_{T}, transfer the signal S_{T} to the antenna 200, and provide both a forward coupled signal SC1 and a reflected path coupled signal SC2 to the feedback receiver 190.

The feedback receiver 190 may capture the coupled signals SC1 and SC2 received from the bi-directional coupler 110 through the feedback path.

The feedback receiver 190 may generate a captured input reflection coefficient γ̌ᵢₙ. based on the coupled signals SC1 and SC2. The captured input reflection coefficient γ̌ᵢₙ may be an indirectly measured value of an input reflection coefficient γᵢₙ with respect to the antenna impedance tuner circuit 150. In an embodiment, the input reflection coefficient γᵢₙ may be an input reflection coefficient measured in association with a preset tune code (e.g., a bypass tune code controlling bypass of passive reactive components within the antenna impedance tuner circuit 150).

The antenna impedance tuner circuit 150 may be located between the bi-directional coupler 110 and the antenna 200.

The antenna impedance tuner circuit 150 may include a variable impedance circuit. For example, the variable impedance circuit may include a variable capacitor, a variable inductor, and a switch. The variable impedance circuit may have various impedance values according to the control of the variable capacitor, the variable inductor, and/or the switch.

The antenna impedance tuner circuit 150 may receive a tune code at from the tuner control circuit 170. The tune code at may be configured as a binary number. The antenna impedance tuner circuit 150 may adjust its impedance in combination with the impedance of the antenna 200 to be close to at least one reference impedance (e.g., optimal impedance) based on the tune code at. For example, the antenna impedance tuner circuit 150 may adjust electrical length (e.g., capacitor, inductor, or resistor) between the antenna 200 and the bi-directional coupler 110 based on the tune code, and thereby adjust the reflection due to the impedance difference between the antenna 200 and the bi-directional coupler 110. The antenna impedance tuner circuit 150 may perform a tuning operation with respect to the signal received from the bi-directional coupler 110 based on the tune code.

The tuner control circuit 170 may determine an optimal tune code a* for maximizing the electric power transferred from the bi-directional coupler 110 to the antenna 200.

In an embodiment, the antenna impedance tuner circuit 150 may apply the tune code corresponding to the impedance of the antenna 200 (i.e., setting the impedance of the antenna impedance tuner circuit in relation to that of the antenna 200), to perform matching of antenna impedance (and minimize reflected power back to the coupler 110).

The tuner control circuit 170 may receive the captured input reflection coefficient γ̌ᵢₙ from the feedback receiver 190. The tuner control circuit 170 may detect a current antenna load (or antenna impedance) based on the captured input reflection coefficient γ̌ᵢₙ. The tuner control circuit 170 may confirm a reflection coefficient Γᵢₙ from an input of the antenna impedance tuner circuit 150 toward the antenna 200 through a reverse and forward voltage ratio of the captured input reflection coefficient γᵢₙ. Hereinafter, for better understanding and ease of description, the reflection coefficient Γᵢₙ from the input of the antenna impedance tuner circuit 150 toward the antenna 200 will be referred to as “input reflection coefficient”.

In an embodiment, in order to confirm the reflection coefficient Γᵢₙ, the tuner control circuit 170 may set a value at which the reflection coefficient Γᵢₙ is matched to an optimal impedance (e.g., about 50 0) as a reference reflection coefficient. In addition, the tuner control circuit 170 may set the tune code such that an input reflection coefficient Γᵢₙ of the antenna impedance tuner circuit 150 is minimized, as a reference tune code.

Hereinafter, for better understanding and ease of description, a reflection coefficient Γₐₙₜ from an output of the antenna impedance tuner circuit 150 toward the antenna 200 will be referred to as “output reflection coefficient”.

In an embodiment, the tuner control circuit 170 may receive measurement data DATA_m and AIT data DATA_AIT stored in a memory (not shown, which may be internal or external of the tuner control circuit 170).

The measurement data DATA_m may include the input reflection coefficient γᵢₙ corresponding to each of a plurality of tune codes (the plurality of tune codes may also be provided along with DATA_m). For example, the measurement data DATA_m may include data indicating the captured input reflection coefficient γᵢₙ when a preset first tune code is applied, with respect to the CL-AIT system 10 having any preset first impedance value. As such, the measurement data DATA_m may be considered reference data which is used for optimizing tuning and minimizing reflected power in real time as the antenna impedance changes due to external conditions.

The AIT data DATA_AIT may be data indicating characteristics with respect to each of a plurality of impedance tuning stages (interchangeably, “stages” or “circuit stages”) within the antenna impedance tuner circuit 150.

In an embodiment, the AIT data DATA_AIT may include data indicating a circuit type of each stage. For example, the circuit type may be a shunt type or a series type based on the manner of connection to the antenna 200. Specifically, when the stage is connected between an inner conductor of a transmission line and ground, the circuit type of the stage may be a shunt type. When the stage is coupled in series with the transmission line, the circuit type of the stage may be a series type.

In an embodiment, the AIT data DATA_AIT may include data indicating a coefficient of each stage. For example, the coefficient of the stage may be a coefficient of the highest order term of the corresponding equation when the circuit within the stage is expressed with an S parameter. For example, the coefficient of the stage may be the number of cases of connecting to a subsequent stage through a passive element (e.g., capacitor or inductor)

Probability theory deals with the number of cases.

In an embodiment, the AIT data DATA_AIT may include data indicating the number of control bits of each stage. For example, the number of control bits may be the number of switches included within the stage.

In an embodiment, the AIT data DATA_AIT may include data indicating a bypass code of each stage. For example, the bypass code may be a code that has a number of bits equal to or less than the number of switches within the corresponding stage, and indicates a switch capable of being connected to a subsequent stage or antenna without passing through a passive element (e.g., capacitor or inductor) within the corresponding stage. The tuner control circuit 170 may model the antenna impedance tuner circuit 150 as having the plurality of stages.

The tuner control circuit 170 may generate a circuit characteristic value with respect to each of the plurality of stages of the antenna impedance tuner circuit 150 based on the measurement data DATA_m and the AIT data DATA_AIT. The circuit characteristic value may include an impedance value of at least one passive element included in the circuit within each stage of the modeled antenna impedance tuner circuit 150. For example, the circuit characteristic value may include an impedance value of the capacitor and/or inductor included within each stage. In addition, the circuit characteristic value may include an impedance value of the transmission line included in the circuit within each stage. For example, the tuner control circuit 170 may calculate a circuit characteristic value of the antenna impedance tuner circuit 150 through open/short/load (OSL) calibration. The tuner control circuit 170 may calculate the S parameter(s) (e.g., reflection coefficient S11, forward transmission coefficient S21, etc.) with respect to each of the plurality of stages within the antenna impedance tuner circuit 150.

The tuner control circuit 170 may calculate an output reflection coefficient Γₐₙₜ based on the measurement data DATA_m and the AIT data DATA_AIT. The tuner control circuit 170 may measure the captured input reflection coefficient γᵢₙ while applying the plurality of tune codes to the antenna impedance tuner circuit 150. The tuner control circuit 170 may determine an optimal tune code among the plurality of tune codes based on the output reflection coefficient Γₐₙₜ and the captured input reflection coefficient γ̌ᵢₙ. In an embodiment, the optimal tune code may be a tune code for which the power loss cost (due to mismatch) calculated according to a voltage standing wave ratio (VSWR) method and/or a relative transducer gain (RTG) method is smallest among the plurality of tune codes. The tuner control circuit 170 may determine the optimal tune code as an optimal tune code a* with respect to the captured input reflection coefficient γ̌ᵢₙ.

FIG. 1 illustrates that the CL-AIT system 10 includes one antenna, but embodiments are not limited thereto. In other examples, the CL-AIT system 10 may include a plurality of antennas.

Meanwhile, FIG. 1 illustrates that the RF PCB 130 and the antenna impedance tuner circuit 150 are configured independently, but the RF PCB 130 (or other transmission line structure) may be included inside the antenna impedance tuner circuit 150 in other embodiments. Hereinafter, for better understanding and ease of description, it will be assumed that the RF PCB 130 is included inside the antenna impedance tuner circuit 150.

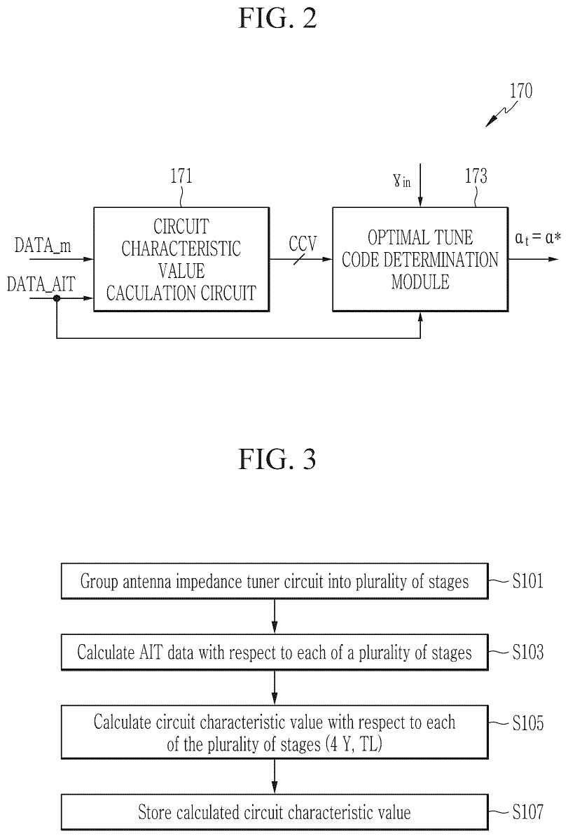

FIG. 2 is a block diagram showing a configuration of a tuner control circuit according to an embodiment.

As shown in FIG. 2, the tuner control circuit 170 may include a circuit characteristic value calculation circuit 171 and an optimal tune code determination processing circuit (“module”) 173.

The circuit characteristic value calculation circuit 171 may group the antenna impedance tuner circuit 150 into the plurality of stages, and may calculate a circuit characteristic value CCV with respect to each of the plurality of stages.

In an embodiment, the circuit characteristic value calculation circuit 171 may include a memory. For example, the memory may be a NAND flash memory. For example, memory may include an electrically erasable programmable read-only memory (EEPROM), a phase change random-access memory (PRAM), resistive RAM (ReRAM), a resistive random-access memory (RRAM), a nano-floating gate memory (NFGM), a polymer random-access memory (PoRAM), a magnetic random-access memory (MRAM), a ferroelectric random-access memory (FRAM) or a memory similar thereto.

The circuit characteristic value calculation circuit 171 may receive the measurement data DATA_m and the AIT data DATA_AIT. Although shown to be received from an external source, in an embodiment, the measurement data DATA_m and the AIT data DATA_AIT may be preset, and may be pre-stored in the memory within the circuit characteristic value calculation circuit 171.

The circuit characteristic value calculation circuit 171 may calculate the circuit characteristic value CCV based on the measurement data DATA_m and the AIT data DATA_AIT. The circuit characteristic value calculation circuit 171 may store the calculated circuit characteristic value CCV in the memory. In an embodiment, the circuit characteristic value CCV may be pre-stored in the memory of the circuit characteristic value calculation circuit 171.

The circuit characteristic value calculation circuit 171 may transfer the circuit characteristic value CCV to the optimal tune code determination module 173.

The optimal tune code determination module 173 may determine an optimal tune code with respect to the input reflection coefficient γᵢₙ measured based on the circuit characteristic value CCV and the AIT data DATA_AIT.

In more detail, the optimal tune code determination module 173 may calculate an impedance (an output reflection coefficient l′ant of FIG. 1) with respect to the antenna 200 based on the circuit characteristic value CCV and the input reflection coefficient γᵢₙ.

The optimal tune code determination module 173 may calculate, while applying each of a plurality of tune code candidates to the antenna impedance tuner circuit 150 based on the calculated impedance with respect to the antenna, the power lost cost of the CL-AIT system 10 according to applying of corresponding tune codes. In an embodiment, the optimal tune code determination module 173 may calculate the power loss cost by using a voltage standing wave ratio (VSWR) method (e.g., a simple correlation of the VSWR value causing S21 insertion loss) and/or a relative transducer gain (RTG) method (where RTG may be understood as the ratio of power delivered to a load divided by power provided from the source).

The optimal tune code determination module 173 may determine a tune code candidate having an optimal power loss cost, among the plurality of tune code candidates, as the optimal tune code. In an embodiment, the optimal tune code determination module 173 may search all of the plurality of tune code candidates, and may determine an optimal tune code candidate as the optimal tune code. In an embodiment, the optimal tune code determination module 173 may detect the optimal tune code by using an optimal value search algorithm. For example, optimal value search algorithm may be a hill-climbing method. Meanwhile, the optimal tune code determination module 173 may detect the optimal tune code by using any other suitable search algorithm in other embodiments.

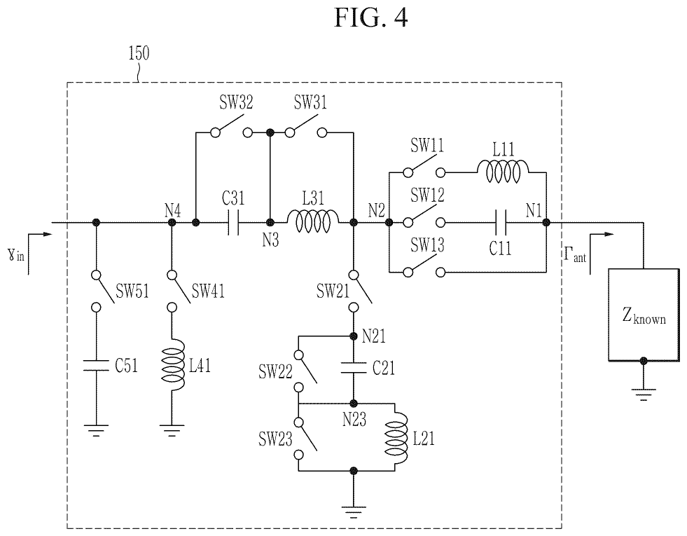

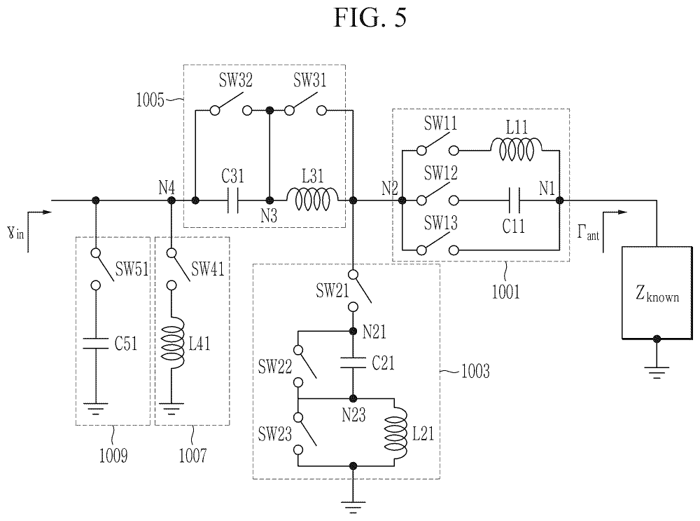

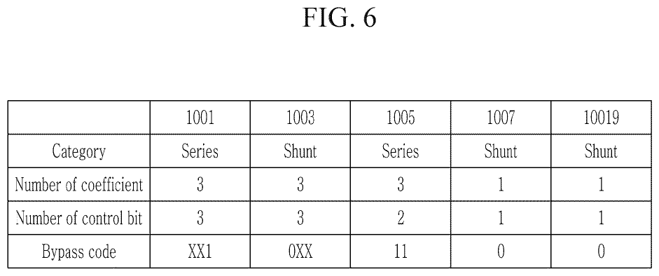

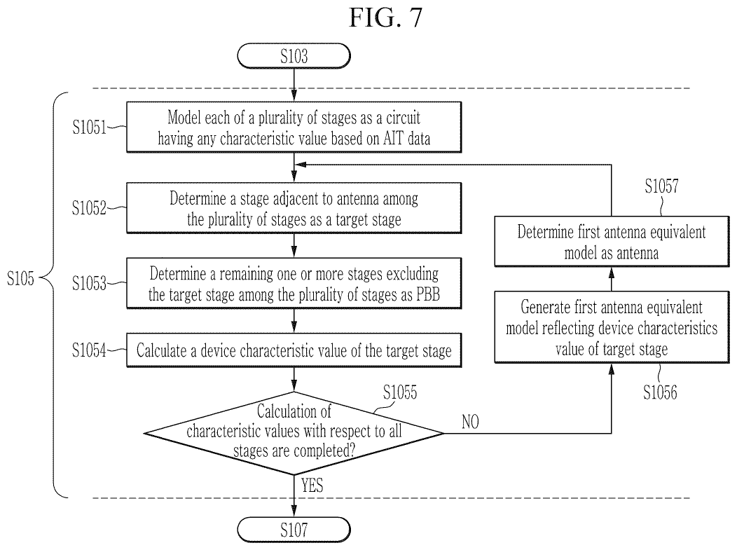

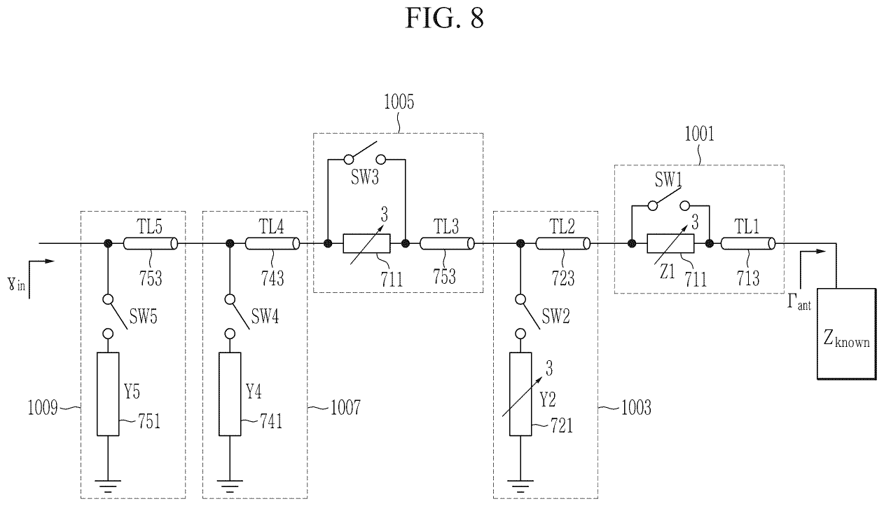

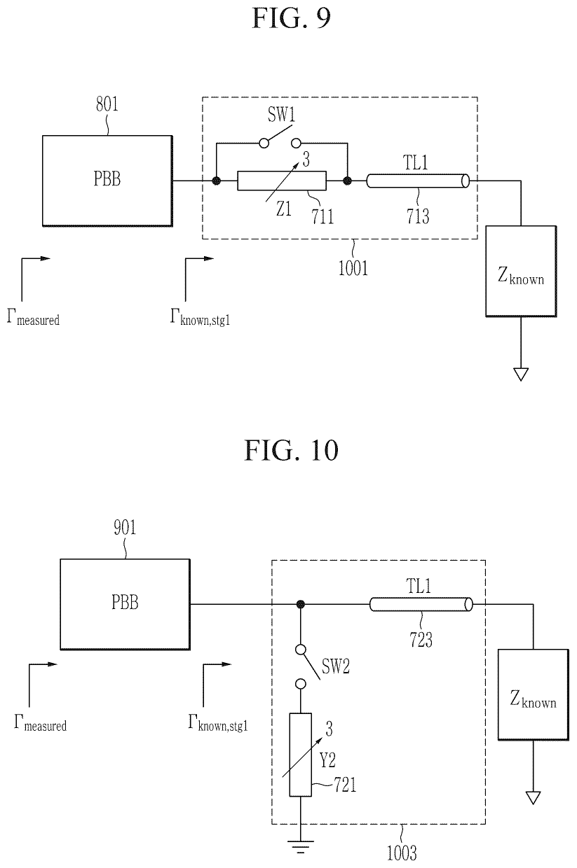

FIG. 3 is a flowchart showing an operation of a tuner control circuit according to an embodiment. FIG. 4 is a circuit diagram showing an exemplary antenna impedance tuner circuit. FIG. 5 is a circuit diagram showing the case of grouping the antenna impedance tuner circuit according to FIG. 4 into the plurality of stages. FIG. 6 is a table showing AIT data of the antenna impedance tuner circuit according to FIG. 4. FIG. 7 is a flow chart showing the case of modeling the antenna impedance tuner circuit according to FIG. 4. FIG. 8 is a circuit model specifically showing the calculating of the circuit characteristic value according to FIG. 3. FIG. 9 is a circuit diagram showing the case where a target stage is a series type. FIG. 10 is a circuit diagram showing the case where a target stage is a shunt type.

Referring to FIG. 3, at operation S101, the circuit characteristic value calculation circuit 171 may group the antenna impedance tuner circuit 150 into the plurality of stages.

In an embodiment, the circuit characteristic value calculation circuit 171 may group the antenna impedance tuner circuit 150 into the plurality of stages using one or more shunt switches and/or one or more series switches.

Referring to FIG. 4, the antenna impedance tuner circuit 150 may include an eleventh switch SW11, a twelfth switch SW12, a thirteenth switch SW13, an eleventh inductor L11, an eleventh capacitor C11, a twenty-first switch SW21, a twenty-second switch SW22, a twenty-third switch SW23, a twenty-first capacitor C21, a twenty-first inductor L21, a thirty-first switch SW31, a thirty-second switch SW32, a thirty-first capacitor C31, a thirty-first inductor L31, a forty-first switch SW41, a forty-first inductor L41, a fifty-first switch SW51, a fifty-first capacitor C51. Here, in the case that the circuit characteristic value calculation circuit 171 calculates the circuit characteristic value CCV, it may be assumed that an impedance Z_{known} is connected to the antenna impedance tuner circuit 150, where the impedance Z_{known} replaces the antenna impedance (as will be described later). The value of the impedance Z_{known} may be preset. Meanwhile, the reflection coefficient toward the impedance Z_{known} may be an output reflection coefficient Γₐₙₜ.

The impedance Z_{known} may be connected between a first node N1 (e.g., an antenna feed point) and ground.

An eleventh switch 11 and the eleventh inductor L11 may be coupled in series between the first node N1 and a second node N2. The twelfth switch SW12 and the eleventh capacitor C11 may be coupled in series between the first node N1 and the second node N2. The thirteenth switch SW13 may be connected between the first node N1 and the second node N2. The eleventh switch SW11 and the eleventh inductor L11, the twelfth switch SW12 and the eleventh capacitor C11, and the thirteenth switch SW13 may be coupled in parallel.

Twenty-first switch SW21 may be connected between the second node N2 and a twenty-first node N21. A twenty-second switch SW22 and the twenty-first capacitor C21 may be coupled in parallel between the twenty-first node N21 and a twenty-third node N23. The twenty-third switch SW23 and the twenty-first inductor L21 may be coupled in parallel between the twenty-third node N23 and ground.

The thirty-first switch SW31 and the thirty-first inductor L31 may be coupled in parallel between the second node N2 and a thirty-first node N3. The thirty-second switch SW32 and the thirty-first capacitor C31 may be coupled in parallel between the thirty-first node N3 and a third node N3.

A forty-first switch SW41 and the forty-first inductor L41 may be coupled in series between a fourth node N4 and the ground.

The fifty-first switch SW51 and the fifty-first capacitor C51 may be coupled in series between the fourth node N4 and ground.

Referring to FIGS. 4 and 5 together, the circuit characteristic value calculation circuit 171 may detect the shunt switch among a plurality of switches SW11, SW12, SW13, SW21, SW22, SW23, SW31, SW32, SW41, and SW51. The circuit characteristic value calculation circuit 171 may calculate a CCV for the circuit 150 for a case in which at least one shunt switch and/or at least one series switch is open or closed, where the at least one shunt switch and the at least one series switch may include one or more among a plurality of switches SW11, SW12, SW13, SW21, SW22, SW23, SW31, SW32, SW41, and SW51. For example, the circuit characteristic value calculation circuit 171 may calculate a CCV for the case in which one or more of the twenty-first switch SW21, the twenty-second switch SW22, the twenty-third switch SW23, the forty-first switch SW41, and the fifty-first switch SW51 are open or closed, among the plurality of switches SW11, SW12, SW13, SW21, SW22, SW23, SW31, SW32, SW41, and SW51, as a shunt switch.

Accordingly, the circuit characteristic value calculation circuit 171 may group the eleventh switch SW11, the twelfth switch SW12, the thirteenth switch SW13, the eleventh inductor L11, and the eleventh capacitor C11 located between the first node N1 and the second node N2 as a first stage 1001.

The circuit characteristic value calculation circuit 171 may group the twenty-first switch SW21, the twenty-second switch SW22, the twenty-third switch SW23, the twenty-first capacitor C21, the twenty-first inductor L21 located between the second node N2 and ground, based on the closing/opening of the twenty-first switch SW21, as a second stage 1003.

The circuit characteristic value calculation circuit 171 may group the thirty-first switch SW31, the thirty-second switch SW32, the thirty-first capacitor C31, and the thirty-first inductor L31 that are between the second node N2 and the fourth node N4, as a third stage 1005.

The circuit characteristic value calculation circuit 171 may group the forty-first switch SW41 and the forty-first inductor L41 that are between the fourth node N4 and ground based on the forty-first switch SW41, as a fourth stage 1007.

The circuit characteristic value calculation circuit 171 may group the fifty-first switch SW51 and the fifty-first capacitor C51 that are between the fourth node N4 and ground based on the fifty-first switch SW51, as a fifth stage 1009.

Referring back to FIG. 3, at operation S103, the circuit characteristic value calculation circuit 171 may obtain the AIT data DATA_AIT with respect to each of the plurality of stages.

Referring to FIG. 5 and FIG. 6 together, the circuit characteristic value calculation circuit 171 may obtain the AIT data DATA_AIT with respect to the first stage 1001 to the fifth stage 1009.

A circuit type of the first stage 1001 may be a series type.

In addition, the first stage 1001 includes a first case in which the current flows through the eleventh inductor L11 as the eleventh switch SW11 is turned-on (closed) and the twelfth switch SW12 and the thirteenth switch SW13 are turned-off (open), a second case in which the current flows through the eleventh capacitor C11 as the twelfth switch SW12 is turned-on and the eleventh switch SW11 and the thirteenth switch SW13 are turned-off, and a third case in which the current flows through the eleventh inductor L11 and the eleventh capacitor C11 as the eleventh switch SW11 and the twelfth switch SW12 is turned-on and the thirteenth switch SW13 are turned-off. Accordingly, a “coefficient” of the first stage 1001 may be 3, where each coefficient represents a different connection scenario with a respective impedance between the input node N2 and the output node N1.

Herein, a “control bit” is a bit that controls a switching state of a respective switch within an impedance stage. The first stage 1001 includes three switches SW11, SW12, and SW13, and accordingly, the number of control bits of the first stage 1001 may be 3.

Herein, a “bypass code” is a code that controls bypassing of all reactive components within a stage, such that the stage, when bypassed, may effectively become just a short transmission line (for a series stage) or a node or short transmission line (for a shunt stage). The first stage 1001 may include the three switches SW11, SW12, and SW13, and connection to the antenna may be enabled without passing through any reactive component of the first state 1001 when the thirteenth switch SW13 is turned-on. As an example, a bypass code of the first stage 1001 may be XX1. Here, X may be any bit of 0 or 1 causing switches SW11 and SW12 to open, and 1 may be a bit causing the thirteenth switch SW13 to close.

A circuit type of the second stage 1003 may be a shunt type.

The second stage 1003 includes a first case in which the current flows through the twenty-first inductor L21 as the twenty-first switch SW21 and the twenty-second switch SW22 are turned-on and the twenty-third switch SW23 is turned-off, a second case in which the current flows through the twenty-first capacitor C21 as the twenty-first switch SW21 and the twenty-third switch SW23 is turned-on and the twenty-second switch SW22 are turned-off, a third case in which the current flows through the twenty-first capacitor C21 and the twenty-first inductor L21 as the twenty-first switch SW21, the twenty-second switch SW22, and the twenty-third switch SW23 are turned-on, and accordingly, a coefficient of the second stage 1003 may be 3.

The second stage 1003 includes three switches SW21, SW22, and SW23, and accordingly, the number of control bits of the second stage 1003 may be 3.

The second stage 1003 may include the three switches SW21, SW22, and SW23, and connection to a subsequent stage may be enabled without passing through a corresponding stage when the twenty-first switch SW21 is turned-off, resulting in that a bypass code of the second stage 1003 may be 0XX. Here, X may be any bit of 0 or 1, and 0 may be a bit indicating the twenty-first switch SW21.

A circuit type of the third stage 1005 may be a series type.

The third stage 1005 includes a first case in which the current flows through the thirty-first capacitor C31 and the thirty-first inductor L31 as the thirty-first switch SW31 and the thirty-second switch SW32 are turned-off, a second case in which the current flows through the thirty-first inductor L31 as the thirty-first switch SW31 is turned-on and the thirty-second switch SW32 are turned-off, a third case in which the current flows through the thirty-first capacitor C31 as the thirty-second switch SW32 is turned-on and the thirty-first switch SW31 are turned-off, and accordingly, a coefficient of the third stage 1005 may be 3.

The third stage 1005 includes two switches SW31 and SW32, and accordingly, the number of control bits of the third stage 1005 may be 2.

The third stage 1005 may include the two switches SW31 and SW32, and connection to the subsequent stage may be enabled without passing through a corresponding stage when the thirty-first switch SW31 is turned-on and the thirty-second switch SW32 is turned-on, resulting in that a bypass code of the third stage 1005 may be 11.

A circuit type of the fourth stage 1007 may be a shunt type.

The fourth stage 1007 includes a first case in which the current flows through the forty-first inductor L41 as the forty-first switch SW41 is turned-on, and accordingly, a coefficient of the fourth stage 1007 may be 1.

The fourth stage 1007 may include one switch SW41, and connection to a subsequent stage may be enabled without passing through a corresponding stage when the forty-first switch SW41 is turned-off, resulting in that a bypass code of the fourth stage 1007 may be 0.

A circuit type of the fifth stage 1009 may be a shunt type.

The fifth stage 1009 includes a first case in which the current flows through the fifty-first capacitor C51 as the fifty-first switch SW51 is turned-on, and accordingly, a coefficient of the fifth stage 1009 may be 1.

The fifth stage 1009 may include one switch SW51, and connection to a subsequent stage may be enabled without passing through any reactive elements of the fifth stage 1009 when the fifty-first switch SW51 is turned-off, such that a bypass code of the fifth stage 1009 may be 0.

Referring back to FIG. 3, at operation S105, the circuit characteristic value calculation circuit 171 may calculate the circuit characteristic value with respect to each of the plurality of stages.

Thereafter, at operation S107, the circuit characteristic value calculation circuit 171 may store the circuit characteristic value calculated at the operation S105. The circuit characteristic value may subsequently be used for real time impedance tuning of the antenna impedance tuner circuit 150.

Meanwhile, the operation S105 of calculating the circuit characteristic value will be described in detail with reference to FIG. 7 to FIG. 10.

First, at operation S1051, the circuit characteristic value calculation circuit 171 may model each of the plurality of stages as a circuit having any characteristic value based on the AIT data DATA_AIT.

In an embodiment, the circuit characteristic value calculation circuit 171 may model each of the plurality of stages of the antenna impedance tuner circuit 150 as a circuit having any characteristic value including that of just a transmission line, or including a transmission line (where each transmission line may be modeled as having a certain electrical length).

Referring to FIGS. 7 and 8 together, since the first stage 1001 is a series type, the circuit characteristic value calculation circuit 171 may model the first stage 1001 as a circuit including a first impedance 711, a first switch SW1 coupled in parallel to the first impedance 711, and a first transmission line 713. Here, a value of the first impedance 711 may be Z1, and an impedance value of the first transmission line 713 may be TL1. Since the coefficient of the first stage 1001 is 3, Z1 may have three different values depending on the selected case.

Since the second stage 1003 is a shunt type, the circuit characteristic value calculation circuit 171 may model the second stage 1003 as a circuit including a second admittance 721, the second switch SW2 coupled in series to the second admittance 721, and a second transmission line 723. Here, a value of the second admittance 721 may be Y2, and an impedance value of the second transmission line 723 may be TL2. Since the coefficient of the second stage 1003 is 3, Y2 may have three different values depending on the selected case.

Since the third stage 1005 is a series type, the circuit characteristic value calculation circuit 171 may model the third stage 1005 as a circuit including a third impedance 731, a third switch SW3 coupled in parallel to the third impedance 731, and a third transmission line 733. Here, a value of the third impedance 731 may be Z3, and an impedance value of the third transmission line 733 may be TL3. Since the coefficient of the third stage 1005 is 3, Z3 may have three different values depending on the selected case.

Since the fourth stage 1007 is a shunt type, the circuit characteristic value calculation circuit 171 may model the fourth stage 1007 as a circuit including a fourth admittance 741, a fourth switch SW4 coupled in series to the fourth admittance 741, and a fourth transmission line 743. Here, a value of the fourth admittance 741 may be Y4, and an impedance value of the fourth transmission line 743 may be TL4.

Since the fifth stage 1009 is a shunt type, the circuit characteristic value calculation circuit 171 may model a fifth stage 1007 as a circuit including a fifth admittance 751, a fifth switch SW5 coupled in series to the fifth admittance 751, and a fifth transmission line 753. Here, a value of the fifth admittance 751 may be Y5, and an impedance value of the fifth transmission line 753 may be TL5.

Referring back to FIG. 7, at operation S1052, the circuit characteristic value calculation circuit 171 may determine a stage closest to the antenna 200 among the plurality of stages, as a target stage.

Referring to FIG. 8, the circuit characteristic value calculation circuit 171 may sequentially calculate the characteristic values of the elements within the corresponding stage, from the stage closest to the antenna. The circuit characteristic value calculation circuit 171 may calculate characteristic values of the elements within the first stage 1001, the second stage 1003, the third stage 1005, the fourth stage 1007, and the fifth stage 1009, i.e., in the sequence of being progressively further from the antenna.

First, the circuit characteristic value calculation circuit 171 may determine the first stage 1001 as the target stage.

At operation S1053, the circuit characteristic value calculation circuit 171 may determine a remaining one or more stages, excluding the target stage among the plurality of stages, as a passive black box (PBB).

Referring to FIGS. 7-9 together, the circuit characteristic value calculation circuit 171 may determine the second stage 1003, the third stage 1005, the fourth stage 1007, and the fifth stage 1009, excluding the first stage 1001 which is the target stage, as a first PBB 801.

At operation S1054, the circuit characteristic value calculation circuit 171 may calculate the device characteristic value of the target stage.

First, prior to connecting the antenna, during a calibration phase, a known impedance Z̅_̅{̅K̅n̅o̅w̅n̅}̅ having a preset value may be connected to the antenna port. This may be expressed as the following Equation 1.

$$\overline{{Z}_{Known}} {=}^{△} [ {Z}_{1} , {Z}_{2} , … , {Z}_{k} ] \qquad ( Equation 1 )$$

Depending on a value of the known impedance Z̅_̅{̅K̅n̅o̅w̅n̅}̅ connected to the antenna port, a value of a measured reflection coefficient Γ̅_̅{̅m̅e̅a̅s̅u̅r̅e̅d̅}̅ obtained by viewing the known impedance Z̅_̅{̅K̅n̅o̅w̅n̅}̅ from the first PBB 801 may be different. The measured reflection coefficient Γ̅_̅{̅m̅e̅a̅s̅u̅r̅e̅d̅}̅ may be expressed as Equation 2.

$$\overline{{Γ}_{measured}} {=}^{△} [ {Γ}_{Z 1} , {Γ}_{Z 2} , … , {Γ}_{Zk} ] \qquad ( Equation 2 )$$

The value of the measured reflection coefficient Γ̅_̅{̅m̅e̅a̅s̅u̅r̅e̅d̅}̅ according to the known value of the impedance Z̅_̅{̅K̅n̅o̅w̅n̅}̅ may be measured in advance (e.g., during the calibration phase).

Meanwhile, when the measured reflection coefficient Γ̅_̅{̅m̅e̅a̅s̅u̅r̅e̅d̅}̅ measured according to the known value of the impedance Z̅_̅{̅K̅n̅o̅w̅n̅}̅ is three or more, the measured reflection coefficient Γ̅_̅{̅m̅e̅a̅s̅u̅r̅e̅d̅}̅ according to the known value of the impedance Z̅_̅{̅K̅n̅o̅w̅n̅}̅ may be expressed as Equation 3.

$$\overline{{Γ}_{measured}} = {S}_{11} + \frac{{S}_{12} {S}_{21} \overline{{Γ}_{Known}}}{1 - {S}_{22} {Γ}_{Known}} \qquad ( Equation 3 )$$

Since the antenna impedance tuner circuit 150 only includes passive elements, S₁₂=S₂₁ (the forward transmission coefficient equals the reverse transmission coefficient) may be satisfied. Therefore, since there are three unknown variables in Equation 3, when there are three or more known impedance Γ̅_̅{̅K̅n̅o̅w̅n̅}̅ values, the S parameter with respect to the antenna impedance tuner circuit 150 may be calculated.

Meanwhile, the S parameter and the ABCD parameter may be converted through Equation 4.

$$[ \begin{matrix}{S}_{11} & {S}_{12} \\ {S}_{21} & {S}_{22}\end{matrix} ] = [ \begin{matrix}\frac{B - {Z}_{n} ( D - A + {CZ}_{n} )}{B + {Z}_{n} ( D + A + {CZ}_{n} )} & \frac{2 {Z}_{n} ( AD + BC )}{B + {Z}_{n} ( D + A + {CZ}_{n} )} \\ \frac{2 {Z}_{n}}{B + {Z}_{n} ( D + A + {CZ}_{n} )} & \frac{B - {Z}_{n} ( A - D + {CZ}_{n} )}{B + {Z}_{n} ( D + A + {CZ}_{n} )}\end{matrix} ] \qquad ( Equation 4 )$$

$$[ \begin{matrix}A & B \\ C & D\end{matrix} ] = [ \begin{matrix}\frac{( 1 + {S}_{11} ) ( 1 - {S}_{22} ) + {S}_{12} {S}_{21}}{2 {S}_{21}} & {Z}_{n} \frac{( 1 + {S}_{11} ) ( 1 - {S}_{22} ) - {S}_{12} {S}_{21}}{2 {S}_{21}} \\ \frac{1}{{Z}_{n}} \frac{1 ( 1 - {S}_{11} ) ( 1 - {S}_{22} ) - {S}_{12} {S}_{21}}{2 {S}_{21}} & \frac{( 1 + {S}_{11} ) ( 1 - {S}_{22} ) + {S}_{12} {S}_{21}}{2 {S}_{21}}\end{matrix} ]$$

(here, Zₙ is Z₀)

Based on the AIT data DATA_AIT, since the first stage 1001 is a series type, the first impedance 711 may be represented with ABCD parameters, as Equation 5.

$$ABCD of series circuit = ( \begin{matrix}1 & Z \\ 0 & 1\end{matrix} ) \qquad ( Equation 5 )$$

(here, Z is an arbitrary constant)

In addition, the first transmission line 713 may be represented with ABCD parameters, as Equation 6.

$$ABCD of TL circuit = ( \begin{matrix}{A}_{TL} & {Z}_{0} {b}_{TL} \\ {Y}_{0} {c}_{TL} & {D}_{TL}\end{matrix} ) {=}^{△} \frac{1}{2 {s}_{21}} ( \begin{matrix}1 + {s}_{21}^{2} & {Z}_{0} ( 1 - {s}_{21}^{2} ) \\ {Y}_{0} ( 1 - {s}_{21}^{2} ) & 1 + {s}_{21}^{2}\end{matrix} ) \qquad ( Equation 6 )$$

(here, Z₀=50Ω,

$${Y}_{0} = \frac{1}{{Z}_{0}} ,$$

and s₂₁ is s₂₁ value among S parameter values of the transmission line).

In addition, the first PBB 801 may be represented with ABCD parameters, as Equation 7.

$${PBB}_{tc} = ( \begin{matrix}{A}_{tc} & {B}_{tc} \\ {C}_{tc} & {D}_{tc}\end{matrix} ) \qquad ( Equation 7 )$$

Here, when the first switch SW1 is turned-on, the current does not flow through the first impedance 711, and accordingly, the first PBB 801 may be expressed as Equation 8.

$${PBB}_{tc , on} = {PBB}_{tc} * ABCD of TL circuit = ( \begin{matrix}{A}_{tc} & {B}_{tc} \\ {C}_{tc} & {D}_{tc}\end{matrix} ) ( \begin{matrix}{A}_{TL} & {Z}_{0} {b}_{TL} \\ {Y}_{0} {b}_{TL} & {D}_{TL}\end{matrix} ) \qquad ( Equation 8 )$$

In addition, when the first switch SW1 is turned-off, the current flows through the first impedance 711, and accordingly, the first PBB 801 may be expressed as Equation 9.

$${PBB}_{tc , off} = {PBB}_{tc} * ABCD of series circuit * ABCD of TL circuit = ( \begin{matrix}{A}_{tc} & {B}_{tc} \\ {C}_{tc} & {D}_{tc}\end{matrix} ) ( \begin{matrix}1 & Z \\ 0 & 1\end{matrix} ) ( \begin{matrix}{A}_{TL} & {Z}_{0} {b}_{TL} \\ {Y}_{0} {b}_{TL} & {D}_{TL}\end{matrix} ) \qquad ( Equation 9 )$$

Based on Equation 8 and Equation 9, Equation 10 may be obtained.

$${{PBB}_{tc , on}}^{- 1} {PBB}_{tc , off} = {( \begin{matrix}{A}_{TL} & {Z}_{0} {b}_{TL} \\ {Y}_{0} {b}_{TL} & {A}_{TL}\end{matrix} )}^{- 1} ( \begin{matrix}1 & Z \\ 0 & 1\end{matrix} ) ( \begin{matrix}{A}_{TL} & {Z}_{0} {b}_{TL} \\ {Y}_{0} {b}_{TL} & {A}_{TL}\end{matrix} ) ≅ ( \begin{matrix}{{A}^{′}}_{tc} & {{B}^{′}}_{tc} \\ {{C}^{′}}_{tc} & {{D}^{′}}_{tc}\end{matrix} ) \qquad ( Equation 10 )$$

(∵ in Equation 6, A_{TL}=D_{TL})

At this time,

$${( \begin{matrix}{A}_{TL} & {Z}_{0} {b}_{TL} \\ {Y}_{0} {b}_{TL} & {A}_{TL}\end{matrix} )}^{- 1} = \frac{1}{{A}_{TL}^{2} - {Z}_{0} {b}_{TL} * {Y}_{0} {b}_{TL}} ( \begin{matrix}{A}_{TL} & - {Z}_{0} {b}_{TL} \\ - {Y}_{0} {b}_{TL} & {A}_{TL}\end{matrix} ) ,$$

and accordingly, Equation 10 may be expressed as Equation 11.

$${( \begin{matrix}{A}_{TL} & - {Z}_{0} {b}_{TL} \\ - {Y}_{0} {b}_{TL} & {A}_{TL}\end{matrix} )}^{- 1} ( \begin{matrix}1 & Z \\ 0 & 1\end{matrix} ) ( \begin{matrix}{A}_{TL} & {Z}_{0} {b}_{TL} \\ {Y}_{0} {b}_{TL} & {A}_{TL}\end{matrix} ) = \frac{1}{{A}_{TL}^{2} - {Z}_{0} {b}_{TL} * {Y}_{0} {b}_{TL}} ( \begin{matrix}{A}_{TL} & - {Z}_{0} {b}_{TL} \\ - {Y}_{0} {b}_{TL} & {A}_{TL}\end{matrix} ) ( \begin{matrix}1 & 0 \\ Y & 1\end{matrix} ) ( \begin{matrix}{A}_{TL} & {Z}_{0} {b}_{TL} \\ {Y}_{0} {b}_{TL} & {A}_{TL}\end{matrix} ) = ( \begin{matrix}1 + {Z}_{0} {A}_{TL} {b}_{TL} {Y}_{0} & {A}_{TL}^{2} {Y}_{0} \\ - {Y}_{0}^{2} {b}_{TL}^{2} {Z}_{0} & 1 - {Z}_{0} {A}_{TL} {b}_{TL} {Y}_{0}\end{matrix} ) ( ∵ {A}_{TL}^{2} - {Z}_{0} {Y}_{0} {b}_{TL}^{2} = {A}_{TL}^{2} - {b}_{TL}^{2} = {( \frac{1 + {s}_{21}^{2}}{2 {s}_{21}} )}^{2} - {( \frac{1 - {s}_{21}^{2}}{2 {s}_{21}} )}^{2} = 1 ) \qquad ( Equation 11 )$$

Therefore, the value of the first impedance 711 may be expressed as Equation 12 below.

Here, the circuit characteristic value calculation circuit 171 may not use a measured value Γ̅_̅{̅m̅e̅a̅s̅u̅r̅e̅d̅}̅ that does not satisfy

$${A}_{TL}^{2} - {Z}_{0} {Y}_{0} {b}_{TL}^{2} = {A}_{TL}^{2} - {b}_{TL}^{2} = {( \frac{1 + {s}_{21}^{2}}{2 {s}_{21}} )}^{2} - {( \frac{1 + {s}_{21}^{2}}{2 {s}_{21}} )}^{2} = 1$$

during the calculation of the circuit characteristic value CCV.

$$Z = {Z}_{0}^{2} {C}_{tc}^{′} + {B}_{tc}^{′} = {ZA}_{TL}^{2} - {Zb}_{TL}^{2} \qquad ( Equation 12 )$$

Here, Z₀ may be the preset value, and C′_{tc} and B′_{tc} may be values calculated based on the measured reflection coefficient Γ̅_̅{̅m̅e̅a̅s̅u̅r̅e̅d̅}̅.

In the same way, the impedance value of the first transmission line 713 may be expressed as Equation 13.

$$TL = \frac{( \frac{{A}_{t c}^{′} - {D}_{t c}^{′}}{{Y}_{0}} ) + ( {B}_{t c}^{′} - {Z}_{0}^{2} {C}_{t c}^{′} )}{z} = \frac{- 2 Z {b}_{T L} + Z ( {A}_{TL}^{2} + {b}_{T L}^{2} )}{z} = {( {A}_{T L} - {b}_{T L} )}^{2} = {s}_{21}^{2} \qquad ( Equation 13 )$$

Since the S parameter with respect to the antenna impedance tuner circuit 150 has been calculated based on Equation 3, the circuit characteristic value calculation circuit 171 may calculate the impedance value of the first transmission line 713.

Referring back to FIG. 7, at operation S1055, the circuit characteristic value calculation circuit 171 may determine whether calculation of characteristic values with respect to all stages is completed.

At operation S1056, when it is determined that the calculation of the characteristic values with respect to all stages has not been completed, the circuit characteristic value calculation circuit 171 may generate a first antenna equivalent model reflecting the device characteristic value of the target stage.

That is, the circuit characteristic value calculation circuit 171 may generate an updated first antenna equivalent model by including an updated impedance

$${Z}_{K n o w n}^{′}$$

including the known impedance Z_{known} and the first stage 1001.

In more detail, the circuit characteristic value calculation circuit 171 may calculate an input impedance Γ_{known,stg1} of the first stage 1001 based on Equation 14.

$${Γ}_{k n o w n , stg 1} = \frac{( Z - {Z}_{0} )}{( Z + {Z}_{0} )} \qquad ( Equation 14 )$$

Based on Equation 14, an input reflection coefficient Γ_{known,stg2} obtained by viewing the first stage 1001 and the known impedance Z_{known} from the second stage 1003, which is the target stage subsequent to the first stage 1001, may be expressed as Equation 15.

$${Γ}_{k n o w n , stg 2} = {s}_{11} + \frac{{s}_{12} * {s}_{21} * {Γ}_{k n own , stg 1}}{1 - {s}_{22} * {Γ}_{known , stg 1}} \qquad ( Equation 15 )$$

The impedance

$${Z}_{K n o w n}^{′}$$

of the first antenna equivalent model with respect to the input reflection coefficient Γ_{known,stg2} may be expressed as Equation 16.

$${Z}_{K n o w n}^{′} = {Z}_{0} \frac{1 + {Γ}_{k n own , stg 2}}{1 - {Γ}_{k n own , stg 2}} \qquad ( Equation 16 )$$

In an embodiment, the circuit characteristic value calculation circuit 171 may generate the first antenna equivalent model having

$${Z}_{K n o w n}^{′}$$

value determined based on Equation 16.

Thereafter, at operation S1057, the circuit characteristic value calculation circuit 171 may determine the first antenna equivalent model as representative of the antenna.

Thereafter, the circuit characteristic value calculation circuit 171 may perform operation S1052.

At the operation S1057, since the updated antenna model was set by including the first stage 1001, at operation S1052, the circuit characteristic value calculation circuit 171 may determine the next closest stage to the antenna among the plurality of stages, as the target stage.

Referring to FIG. 8, since the second stage 1003 is the next closest stage to the antenna from the first stage 1001, the second stage 1003 may be determined as the next target stage.

At operation S1053, the circuit characteristic value calculation circuit 171 may determine the remaining stage excluding the target stage among the plurality of stages as a passive black box (PBB).

Referring to FIGS. 8 and 10 together, the circuit characteristic value calculation circuit 171 may determine the third stage 1005, the fourth stage 1007, and the fifth stage 1009, excluding the second stage 1003 which is the target stage, as a second PBB 901.

At operation S1054, the circuit characteristic value calculation circuit 171 may calculate the device characteristic value of the target stage.

Since the second stage 1003 is a shunt type based on the AIT data DATA_AIT, the second admittance 721 may be represented with ABCD parameters, as Equation 17.

$$ABCD of shunt circuit = ( \begin{matrix}1 & 0 \\ Y & 1\end{matrix} ) \qquad ( Equation 17 )$$

(here, Y is an arbitrary constant)

In addition, the second transmission line 723 may be represented with ABCD parameters, as Equation 18.

$$ABCD of TL circuit = ( \begin{matrix}{A}_{T L} & {Z}_{0} {b}_{TL} \\ {Y}_{0} {c}_{T L} & {D}_{T L}\end{matrix} ) {=}^{Δ} \frac{1}{2 {s}_{21}} ( \begin{matrix}1 + {s}_{21}^{2} & {Z}_{0} ( 1 - {s}_{21}^{2} ) \\ {Y}_{0} ( 1 - {s}_{21}^{2} ) & 1 + {s}_{21}^{2}\end{matrix} ) \qquad ( Equation 18 )$$

(here, Z₀=50Ω,

$${Y}_{0} = \frac{1}{{Z}_{0}} ,$$

and s₂₁ is s₂₁ value among S parameter values of the transmission line)

The second PBB 901 may be represented with ABCD parameters, as Equation 19.

$$P B {B}_{tc} = ( \begin{matrix}{A}_{t c} & {B}_{t c} \\ {C}_{t c} & {D}_{t c}\end{matrix} ) \qquad ( Equation 19 )$$

Here, when the second switch SW2 is turned-on, the current flows through the second admittance 721, and accordingly, the second PBB 901 may be expressed as Equation 20.

$$P B {B}_{t c , o n} = ( \begin{matrix}{A}_{t c} & {B}_{t c} \\ {C}_{t c} & {D}_{t c}\end{matrix} ) ( \begin{matrix}1 & 0 \\ Y & 1\end{matrix} ) ( \begin{matrix}{A}_{T L} & {Z}_{0} {b}_{TL} \\ {Y}_{0} {b}_{T L} & {D}_{T L}\end{matrix} ) \qquad ( Equation 20 )$$

In addition, when the first switch SW1 is turned-off, the current does not flow through the second admittance 721, and accordingly, the second PBB 901 may be expressed as Equation 21.

$$P B {B}_{tc , off} = ( \begin{matrix}{A}_{t c} & {B}_{t c} \\ {C}_{t c} & {D}_{t c}\end{matrix} ) ( \begin{matrix}{A}_{T L} & {Z}_{0} {b}_{TL} \\ {Y}_{0} {b}_{T L} & {D}_{T L}\end{matrix} ) \qquad ( Equation 21 )$$

Based on Equation 20 and Equation 22, Equation 22 may be obtained.

$${PBB}_{tc , off}^{- 1} PB {B}_{t c , o n} = {( \begin{matrix}{A}_{T L} & {Z}_{0} {b}_{TL} \\ {Y}_{0} {b}_{T L} & {A}_{T L}\end{matrix} )}^{- 1} ( \begin{matrix}1 & 0 \\ Y & 1\end{matrix} ) ( \begin{matrix}{A}_{T L} & {Z}_{0} {b}_{TL} \\ {Y}_{0} {b}_{T L} & {A}_{T L}\end{matrix} ) \qquad ( Equation 22 )$$

(∵ in Equation 18, A_{TL}=D_{TL})

Since

$${( \begin{matrix}{A}_{T L} & {Z}_{0 , T L} \\ {Y}_{0} {b}_{T L} & {A}_{T L}\end{matrix} )}^{- 1} = \frac{1}{{A}_{T L}^{2} - {Z}_{0} {b}_{TL} * {Y}_{0} {b}_{TL}} ( \begin{matrix}{A}_{T L} & - {Z}_{0} {b}_{TL} \\ - {Y}_{0} {b}_{T L} & {A}_{T L}\end{matrix} ) ,$$

Equation 22 may be expressed as Equation 23.

$${( \begin{matrix}{A}_{TL} & {Z}_{0} {b}_{TL} \\ {Y}_{0} {b}_{TL} & {A}_{TL}\end{matrix} )}^{- 1} ( \begin{matrix}1 & 0 \\ Y & 1\end{matrix} ) ( \begin{matrix}{A}_{TL} & {Z}_{0} {b}_{TL} \\ {Y}_{0} {b}_{TL} & {A}_{TL}\end{matrix} ) = ( \begin{matrix}{A}_{TL} & - {Z}_{0} {b}_{TL} \\ - {Y}_{0} {b}_{TL} & {A}_{TL}\end{matrix} ) ( \begin{matrix}1 & 0 \\ Y & 1\end{matrix} ) ( \begin{matrix}{A}_{TL} & {Z}_{0} {b}_{TL} \\ {Y}_{0} {b}_{TL} & {A}_{TL}\end{matrix} ) = ( \begin{matrix}1 - {Z}_{0} {A}_{TL} {b}_{TL} Y & - {Z}_{0}^{2} {b}_{TL}^{2} Y \\ {A}_{TL}^{2} Y & 1 + {Z}_{0} {A}_{TL} {b}_{TL} Y\end{matrix} ) \qquad ( Equation 23 )$$

$$( ∵ {A}_{TL}^{2} - {Z}_{0} {Y}_{0} {b}_{TL}^{2} = {A}_{TL}^{2} - {b}_{TL}^{2} = {( \frac{1 + {s}_{21}^{2}}{2 {s}_{21}} )}^{2} - {( \frac{1 - {s}_{21}^{2}}{2 {s}_{21}} )}^{2} = 1 )$$

Therefore, the value of the second admittance 721 may be expressed as Equation 24.

Here, the circuit characteristic value calculation circuit 171 may not use the measured value Γ̅_̅{̅m̅e̅a̅s̅u̅r̅e̅d̅}̅ (and may disqualify a corresponding tune code that results in the measured value) that does not satisfy

$${A}_{TL}^{2} - {Z}_{0} {Y}_{0} {b}_{TL}^{2} = {A}_{TL}^{2} - {b}_{TL}^{2} = {( \frac{1 + {s}_{21}^{2}}{2 {s}_{21}} )}^{2} - {( \frac{1 - {s}_{21}^{2}}{2 {s}_{21}} )}^{2} = 1$$

during the calculation of the circuit characteristic value CCV.

$$Y = {C}_{tc}^{′} + \frac{{B}_{tc}^{′}}{{z}_{0}^{2}} = {A}_{TL}^{2} Y - {b}_{TL}^{2} Y \qquad ( Equation 24 )$$

Here, Z₀ may be the preset value, and

$${C}_{tc}^{′} , {B}_{tc}^{′}$$

may be values calculated based on the measured reflection coefficient Γ̅_̅{̅m̅e̅a̅s̅u̅r̅e̅d̅}̅.

In the same way, the impedance value of the second transmission line 723 may be expressed as Equation 25.

$$T L = \frac{( \frac{{A}_{tc}^{′} - {D}_{tc}^{′}}{{z}_{0}} ) + ( {C}_{tc}^{′} - \frac{{B}_{tc}^{′}}{{z}_{0}^{2}} )}{Y} = {( {A}_{TL} - {b}_{TL} )}^{2} = {s}_{21}^{2} \qquad ( Equation 25 )$$

Since the S parameter with respect to the antenna impedance tuner circuit 150 has been calculated based on Equation 3, the circuit characteristic value calculation circuit 171 may calculate the impedance value of the second transmission line 723.

Thereafter, at operation S1055, the circuit characteristic value calculation circuit 171 may determine whether calculation of characteristic values with respect to all stages is completed.

Referring to FIG. 9 and FIG. 10, as described above, the circuit characteristic value calculation circuit 171 may perform the calculation of the characteristic values with respect to all stages by repeating operations S1052 to S1055.

When the calculation of the characteristic values with respect to all stages is completed, the circuit characteristic value calculation circuit 171 may store the calculated circuit characteristic value in operation S107.

Meanwhile, as described above, the circuit characteristic value calculation circuit 171 may calculate as many characteristic values as the available number of cases for each stage. For example, since the coefficient of the first stage 1001 is 3, the value of Z to be calculated by the circuit characteristic value calculation circuit 171 may be 3. In this case, the circuit characteristic value calculation circuit 171 may obtain three pairs of (Z, TL) with respect to the first stage 1001 by repeating the above-described operation.

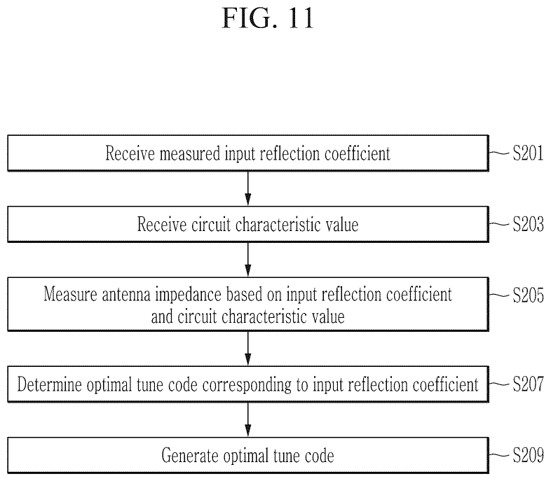

FIG. 11 is a flowchart showing an operation of an optimal tune code determination circuit (“module”) according to an embodiment.

First, at operation S201, the optimal tune code determination module 173 may receive the measured input reflection coefficient.

In an embodiment, the optimal tune code determination module 173 may receive the captured input reflection coefficient γᵢₙ from the feedback receiver 190.

At operation S203, the optimal tune code determination module 173 may receive the circuit characteristic value CCV.

In an embodiment, the optimal tune code determination module 173 may receive the circuit characteristic value CCV with respect to each of the plurality of stages within the antenna impedance tuner circuit 150 from the circuit characteristic value calculation circuit 171.

As described above, the optimal tune code determination module 173 may receive the circuit characteristic value CCV of the modeled antenna impedance tuner circuit 150.

At operation S205, the optimal tune code determination module 173 may measure the antenna impedance based on the input reflection coefficient γᵢₙ and the circuit characteristic value CCV.

The optimal tune code determination module 173 may calculate an S parameter of each stage according to the application of a first candidate tune code among the plurality of tune code candidates to the antenna impedance tuner circuit 150 based on the circuit characteristic value CCV. The optimal tune code determination module 173 may calculate a value of the output reflection coefficient Γₐₙₜ based on the input reflection coefficient γᵢₙ, the S parameter of each stage according to the application of the first candidate tune code, and a corresponding first circuit characteristic value CCV. The optimal tune code determination module 173 may calculate the antenna impedance based on the output reflection coefficient Γₐₙₜ.

Meanwhile, when a plurality of the circuit characteristic values CCV exist for one stage, the optimal tune code determination module 173 may calculate the antenna impedance by using a characteristic value for which the value calculated according to Equation 26 is close to 1.

$${A}_{TL}^{2} - {Z}_{0} {Y}_{0} {b}_{TL}^{2} = {A}_{TL}^{2} - {b}_{TL}^{2} = {( \frac{1 + {s}_{21}^{2}}{2 {s}_{21}} )}^{2} - {( \frac{1 - {s}_{21}^{2}}{2 {s}_{21}} )}^{2} \qquad ( Equation 26 )$$

At operation S207, the optimal tune code determination module 173 may determine the optimal tune code corresponding to the input reflection coefficient γᵢₙ.

In more detail, the optimal tune code determination module 173 may calculate a second circuit characteristic value CCV with respect to a second candidate tune code among the plurality of tune code candidates based on the circuit characteristic value CCV. The optimal tune code determination module 173 may calculate an S parameter of each stage according to the application of the second candidate tune code to the antenna impedance tuner circuit 150. The optimal tune code determination module 173 may calculate the power loss cost with respect to the second candidate tune code based on the second circuit characteristic value CCV, the S parameter of each stage according to the application of the second candidate tune code to the antenna impedance tuner circuit 150, and the calculated output reflection coefficient Γₐₙₜ.

In an embodiment, the optimal tune code determination module 173 may calculate a power loss cost with respect to the second candidate tune code by using the voltage standing wave ratio (VSWR) method and/or the relative transducer gain (RTG) method.

Similarly, the optimal tune code determination module 173 may calculate the power loss cost with respect to each of the plurality of tune code candidates.

The optimal tune code determination module 173 may determine a tune code candidate having an optimal power loss cost, among the plurality of tune code candidates, as the optimal tune code.

In an embodiment, the optimal tune code determination module 173 may detect the optimal tune code by using an optimal value search algorithm. For example, optimal value search algorithm may be a hill-climbing method.

In an embodiment, the optimal tune code determination module 173 may determine the optimal tune code a* excluding a tune code that does not satisfy

$${A}_{TL}^{2} - {Z}_{0} {Y}_{0} {b}_{TL}^{2} = {A}_{TL}^{2} - {b}_{TL}^{2} = {( \frac{1 + {s}_{21}^{2}}{2 {s}_{21}} )}^{2} - {( \frac{1 - {s}_{21}^{2}}{2 {s}_{21}} )}^{2} = 1$$

among the measured value Γ̅_̅{̅m̅e̅a̅s̅u̅r̅e̅d̅}̅.

At operation S209, the optimal tune code determination module 173 may generate the optimal tune code.

In an embodiment, the optimal tune code determination module 173 may generate the optimal tune code a*, and may control the antenna impedance tuner circuit 150 based on the optimal tune code a*.

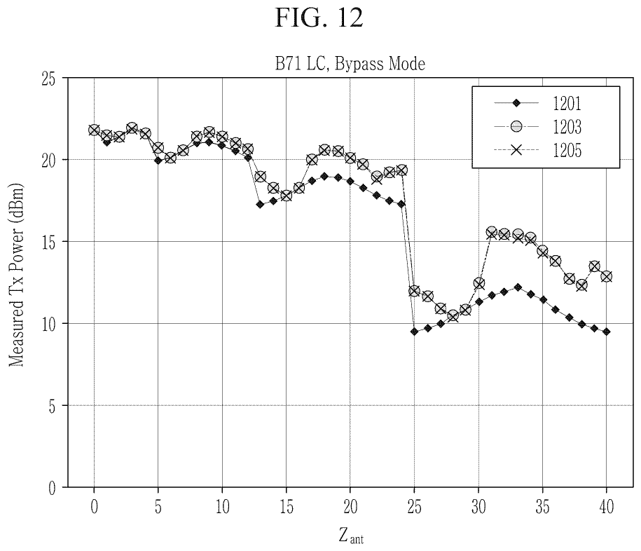

FIG. 12 is a graph showing an measured transmitted power according to an antenna impedance (“Zant”) in a low-frequency band.

In more detail, the transmitted power was measured in the case that signals of a low-frequency band are transmitted from the bi-directional coupler 110 according to the antenna impedance from 0 to 40 ohms.

A first graph 1201 is a graph representing the transmitted power in the case that a signal transmitted from the bi-directional coupler 110 passes through a detour path within the antenna impedance tuner circuit 150.

A second graph 1203 is a graph representing the transmitted power in the case that the signal transmitted from the bi-directional coupler 110 is ideally transferred to the antenna 200.

A third graph 1205 is a graph representing the transmitted power in the case that the signal transmitted from the bi-directional coupler 110 passes through the antenna impedance tuner circuit 150 controlled according to the tuner control circuit 170 according to an embodiment.

As shown in the third graph 1205, the CL-AIT system 10 according to an embodiment may have a transmitted power that is very similar to an ideal case of the second graph 1203. Accordingly, the CL-AIT system 10 according to an embodiment may perform an optimal impedance tuning in the low-frequency band.

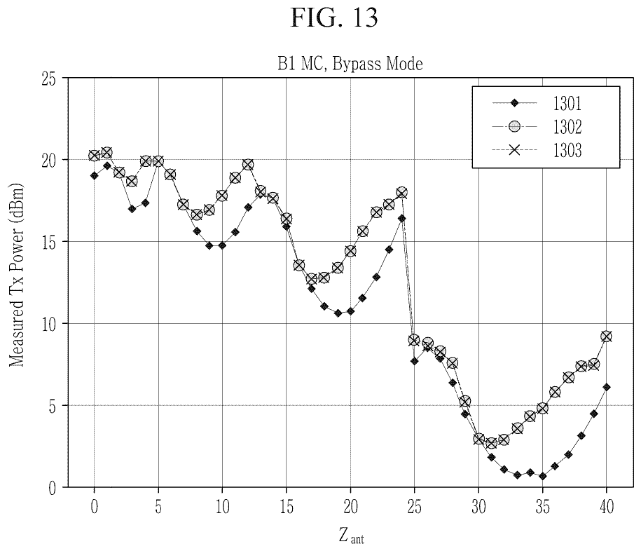

FIG. 13 is a graph showing a measured transmitted power according to an antenna impedance in a mid-frequency band.

In more detail, the transmitted power was measured in the case that signals of a mid-frequency band are transmitted from the bi-directional coupler 110 according to the antenna impedance from 0 to 40 ohms.

A first graph 1301 is a graph representing the transmitted power in the case that the signal transmitted from the bi-directional coupler 110 passes through a detour path within the antenna impedance tuner circuit 150.

A second graph 1303 is a graph representing the transmitted power in the case that the signal transmitted from the bi-directional coupler 110 is ideally transferred to the antenna 200.

A third graph 1305 is a graph representing the transmitted power in the case that the signal transmitted from the bi-directional coupler 110 passes through the antenna impedance tuner circuit 150 controlled according to the tuner control circuit 170 according to an embodiment.

As shown in the third graph 1305, the CL-AIT system 10 according to an embodiment may have the measured transmitted power that is very similar to ideal the second graph 1303. Accordingly, the CL-AIT system 10 according to an embodiment may perform an optimal impedance tuning in the mid-frequency band.

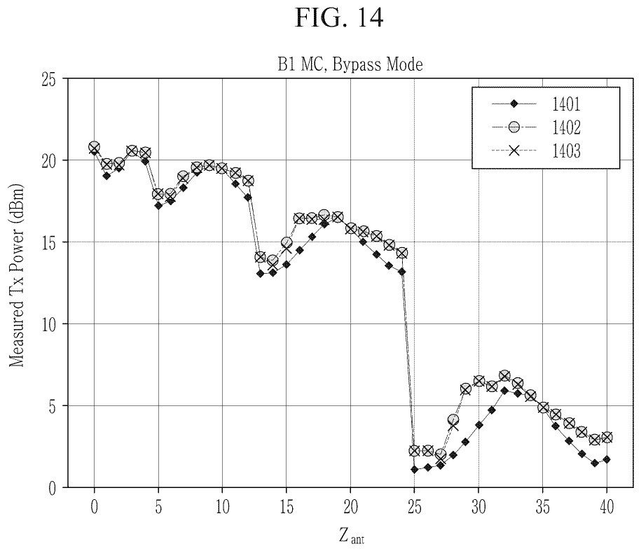

FIG. 14 is a graph showing a measured transmitted power according to an antenna impedance in a high-frequency band.

In more detail, the transmitted power was measured in the case that signals of a high-frequency band are transmitted from the bi-directional coupler 110 according to the antenna impedance from 0 to 40 ohms.

A first graph 1401 is a graph representing the transmitted power in the case that the signal transmitted from the bi-directional coupler 110 passes through a detour path within the antenna impedance tuner circuit 150.

A second graph 1403 is a graph representing the transmitted power in the case that the signal transmitted from the bi-directional coupler 110 is ideally transferred to the antenna 200.

A third graph 1405 is a graph representing the transmitted power in the case that the signal transmitted from the bi-directional coupler 110 passes through the antenna impedance tuner circuit 150 controlled according to the tuner control circuit 170 according to an embodiment.

As shown in the third graph 1405, the CL-AIT system 10 according to an embodiment may have the measured transmitted power that is very similar to ideal the second graph 1403. Accordingly, the CL-AIT system 10 according to an embodiment may perform an optimal impedance tuning in the high-frequency band.

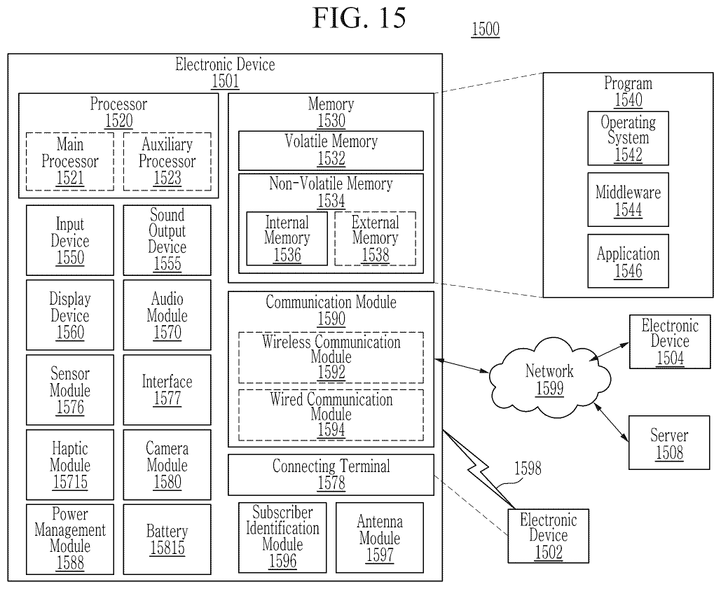

FIG. 15 is a block diagram of an electronic device according to an embodiment.

Referring to FIG. 15, an electronic device 1501 in a network environment 1500 may communicate with an electronic device 1502 through a first network 1598 (for example, short-range wireless communication network). Alternatively, the electronic device 1501 in the network environment 1500 may communicate with an electronic device 1504 or a server 1508 through a second network 1599 (for example, long-range wireless communication network). According to an embodiment, the electronic device 1501 may communicate with the electronic device 1504 through the server 1508.

According to an embodiment, the electronic device 1501 may include a processor 1520, a memory 1530, an input device 1550, an acoustic output device 1555, a display device 1560, an audio module 1570, a sensor module 1576, an interface 1577, a haptic module 1579, a camera module 1580, an electric power management module 1588, a battery 1589, a communication module 1590, a subscriber identifying module 1596, or an antenna module 1597. In an embodiment, in the electronic device 1501, at least one (e.g., the display device 1560 or the camera module 1580) of these components may be omitted, or one or more other components may be added. In an embodiment, portions of these components may be implemented as one integrated circuit. For example, the sensor module 1576 (for example, a fingerprint sensor, an iris sensor, or an illumination sensor) may be embedded and implemented in the display device 1560 (for example, a display).

For example, the processor 1520 may execute software (e.g., a program 1540) to control at least one other components (e.g., hardware or software component) of the electronic device 1501 connected to the processor 1520, and may perform various data processing or operations. According to an embodiment, as at least a portion of data processing or operation, the processor 1520 may load instruction or data received from other components (e.g., the sensor module 1576 or the communication module 1590) in a volatile memory 1532, process the instruction or data stored in the volatile memory 1532, and store the resultant data in a non-volatile memory 1534. According to an embodiment, the processor 1520 may include a main processor 1521 (for example, central processing unit or application processor), and an auxiliary processor 1523 (for example, a graphics processing unit, an image signal processor, a sensor hub processor, or a communication processor) that is operable independently or together with the main processor 1521. Additionally or alternatively, the auxiliary processor 1523 may consume a lower electric power than the main processor 1521, or may be set to be specialized for a designated function. The auxiliary processor 1523 may be implemented separately from, or as part of, the main processor 1521.

The auxiliary processor 1523 may control at least a portion of functions or states related to at least one component (e.g., the display device 1560, the sensor module 1576, or the communication module 1590) among the components of the electronic device 1501. For example, the auxiliary processor 1523 may operate instead of the main processor 1521 while the main processor 1521 is in an inactive (e.g., sleep) state, or may operate together with the main processor 1521 while the main processor 1521 is in an active (e.g., execution of application) state. According to an embodiment, the auxiliary processor 1523 (for example, image signal processor communication processor) may be implemented as a portion of other functionally related components (e.g., the camera module 1580 or the communication module 1590).

The memory 1530 may store various data used by at least one component (e.g., the processor 1520 or the sensor module 1576) of the electronic device 1501. The data may include, for example, input data or output data with respect to software (e.g., the program 1540) and instructions related thereto. The memory 1530 may include the volatile memory 1532 or the non-volatile memory 1534.

The program 1540 may be stored in the memory 1530 as software, and may include, for example, an operating system 1542, a middleware 1544 or an application 1546.

The input device 1550 may receive instruction or data to be used for components (e.g., the processor 1520) of the electronic device 1501 from the outside (e.g., user) of the electronic device 1501. The input device 1550 may include, for example, a microphone, a mouse, a keyboard, or a digital pen (e.g., stylus pen).

The acoustic output device 1555 may output acoustic signal as an exterior of the electronic device 1501. The acoustic output device 1555 may include, for example, a speaker or a receiver. The speaker can be used for general purposes such as multimedia playback or recording playback, and the receiver can be used to receive incoming calls. According to an embodiment, the receiver may be implemented separately from, or as part of, the speaker.

The display device 1560 may visually provide information to the outside (e.g., user) of the electronic device 1501. The display device 1560 may include, for example, a display, a hologram device, or a projector, and a control circuit for controlling the device. According to an embodiment, the display device 1560 may include a predetermined touch circuit (touch circuitry) to detect a touch, or a predetermined sensor circuit (e.g., pressure sensor) to measure the strength of the force generated by the touch.

The audio module 1570 may convert sound into an electric signal, or conversely, convert an electrical signal into sound. According to an embodiment, the audio module 1570 may obtain sound through the input device 1550, or may output sound through the acoustic output device 1555, or an external electronic device (e.g., the electronic device 1502) (e.g., speaker or headphone) connected directly or wirelessly to the electronic device 1501.

The sensor module 1576 may detect the operation state (e.g., electric power or temperature) or the external environment state (e.g., user state), of the electronic device 1501, and may generate an electrical signal or data value corresponding to the detected state. According to an embodiment, the sensor module 1576 may include, for example, a gesture sensor, a gyro sensor, an air pressure sensor, a magnetic sensor, an acceleration sensor, a grip sensor, a proximity sensor, a color sensor, an infrared (IR) sensor, a biometric sensor, a temperature sensor, a humidity sensor, or an illumination sensor.

The interface 1577 may support one or more designated protocols that can be used for the electronic device 1501 to be connected directly or wirelessly to the external electronic device (e.g., the electronic device 1502). According to an embodiment, the interface 1577 may include, for example, a high-definition multimedia interface (HDMI), a universal serial bus (USB) interface, an SD card interface, or an audio interface.

A connection terminal 1578 may include a connector through which the electronic device 1501 can be physically connected to the external electronic device (e.g., the electronic device 1502). According to an embodiment, the connection terminal 1578 may include, for example, an HDMI connector, a USB connector, an SD card connector, or an audio connector (e.g., headphone connector).

The haptic module 1579 can convert electrical signals into mechanical stimulation (e.g., vibration or movement) or electrical stimulation that the user can perceive through tactile or kinesthetic senses. According to an embodiment, the haptic module 1579 may include, for example, a motor, a piezoelectric element, or an electrical stimulation device.

The camera module 1580 may photograph still images and motion images. According to an embodiment, the camera module 1580 may include one or more lenses, image sensors, image signal processors, or flashes.

The electric power management module 1588 may manage the electric power supplied to the electronic device 1501. According to an embodiment, the electric power management module 1588 may be implemented as, for example, at least a portion of a power management integrated circuit (PMIC).

The battery 1589 may supply the electric power to at least one component of the electronic device 1501. According to an embodiment, the battery 1589 may include, for example, a non-rechargeable primary cell, a rechargeable secondary cell, or a fuel cell.

The communication module 1590 may support establishment of a direct (e.g., in a wired manner) communication channel or wireless communication channel between the electronic device 1501 and the external electronic device (e.g., the electronic device 1502, the electronic device 1504, or the server 1508), and performing communication through the established communication channel. The communication module 1590 may be operated independently from the processor 1520 (for example, application processor), and may include one or more communication processors that support direct (e.g., in a wired manner) communication or wireless communication. According to an embodiment, the communication module 1590 may include a wireless communication module 1592 (for example, a cellular communication module, a short-range wireless communication module, or a global navigation satellite system (GNSS) communication module) or a wired communication module 1594 (for example, a local area network (LAN) communication module, or a power line communication module). A corresponding communication module among these communication modules may communicate with an external electronic device 1504 through the first network 1598 (for example, a short-range communication network such as Bluetooth, WiFi direct or infrared data association (IrDA)) or the second network 1599 (for example, a long-range communication network such as a cellular network, the Internet, or a computer network (e.g., LAN or WAN)). These various types of communication modules may be integrated into one component (e.g., a single chip) or may be implemented as a plurality of separate components (e.g., multiple chips). The wireless communication module 1592 may confirm and authenticate the electronic device 1501 within the communication network such as the first network 1598 or the second network 1599 by using the subscriber information (e.g., international mobile subscriber identifier (IMSI)) stored in the subscriber identifying module 1596.

The antenna module 1597 may transmit or receive signals or power to or from the outside (e.g., an external electronic device).

In the past, the antenna module assumed that the antenna impedance tuner circuit, the transmission line, and the entire matching network were one black box, and then stored the S parameter values according to all tune codes. At this time, the antenna impedance tuner circuit may change the impedance value of the interior switch and capacitor according to the tune code. Therefore, the antenna module stored the S parameter values according to all tune codes. At this time, the reverse power of the tune code with bad S21 is very small regardless of the antenna impedance, so accurate calibration is not possible with RFIC measurement specifications, and the performance decrease of CL-AIT was inevitable as the tune code with bad S21 is removed and operated. Meanwhile, when increasing the number of the candidate tune codes to increase matching precision, the time required for compensation and the required memory increased.

According to an embodiment, the antenna module 1597 may perform the impedance matching with respect to the input reflection coefficient based on the AIT data indicating characteristics with respect to the structure of the antenna impedance tuner circuit. Here, the AIT data may group the antenna impedance tuner circuit into the plurality of stages based on the shunt switch, and each of the plurality of stages may be a characteristic value of a circuit modeled by including the transmission line. Accordingly, the antenna module 1597 may calibrate the effects of phase delays and the small loss generated in a short transmission line within the antenna impedance tuner circuit for each stage.

In addition, the antenna module 1597 may calculate the S parameter according to applying of each of the entire candidate tune codes to the antenna impedance tuner circuit for each of the plurality of stages based on the AIT data with respect to each of the plurality of stages. Accordingly, the antenna module 1597 requires less memory capacity and can perform calibration within a shorter time. In addition, the antenna module 1597 may use valid measurement values to derive characteristic values by using the verification equations (e.g., Equation 11 and Equation 23), and accordingly, may accurately calculate the S parameter. That is, the antenna module 1597 may be able to extract precise characteristic values with respect to specific tune codes that could not be calibrated due to the measurement error.

At least a portion among the components may be connected to each other through a communication scheme (e.g., bus, general purpose input and output (GPIO), serial peripheral interface (SPI), or mobile industry processor interface (MIPI)) between peripheral devices, and may exchange signals (e.g., instruction or data) with each other.

According to an embodiment, the instruction or data may be transmitted or received between the electronic device 1501 and the external electronic device 1504 through the server 1508 connected to the second network 1599. Each of the external electronic devices 1502 and 104 may be the same or different type of device from the electronic device 1501. According to an embodiment, all or a part of operations executed in the electronic device 1501 may be executed in the exterior electronic devices of at least one among the external electronic devices 1502, 104, or 108. For example, when the electronic device 1501 needs to perform a certain function or service automatically, or in response to a request from a user or other devices, the electronic device 1501 may request one or more external electronic devices to perform at least a portion of that function or service, instead of executing the function or service on its own, or additionally thereto. The one or more external electronic devices having received the request may execute at least a portion of the requested function or service, or an additional function or service related to the request, and may transfer the result of execution to the electronic device 1501. The electronic device 1501 may provide the results as at least a portion of a response with respect to the request, as it is or by applying additional processing. To this end, for example, cloud computing, distributed computing, or client-server computing technologies may be used.

Electronic devices according to various embodiments disclosed in this document may be of various types. Electronic devices may include, for example, portable communication devices (e.g., smartphones), computer devices, portable multimedia devices, portable medical devices, cameras, wearable devices, or home appliances. Electronic devices according to embodiments of this document are not limited to the above-described devices.

Each component or a combination of two or more components described with reference to FIG. 1 to FIG. 15 may be implemented as a digital circuit, a programmable or non-programmable logic device or array, an application specific integrated circuit (ASIC), etc.

While the inventive concepts have been described in connection with what is presently considered to be practical embodiments, it is to be understood that the inventive concepts are not limited to the disclosed embodiments. On the contrary, it is intended to cover various modifications and equivalent arrangements included within the spirit and scope of the appended claims.

What is claimed is:

1. An impedance tuning system comprising:
an antenna;
a bi-directional coupler configured to transfer an input transmit path signal to the antenna;
a feedback receiver configured to generate an input reflection coefficient based on a coupled signal received from the bi-directional coupler;
an antenna impedance tuner circuit connected between the antenna and the bi-directional coupler, and comprising a plurality of stages; and
a tuner control circuit configured to determine an optimal tune code based on a circuit characteristic value, which is calculated based on an impedance value of a passive element included in each of the plurality of stages and the input reflection coefficient, and control the antenna impedance tuner circuit based on the optimal tune code.

2. The impedance tuning system of claim 1, wherein the tuner control circuit is configured to:
calculate a first S parameter of the antenna impedance tuner circuit according to application of a first candidate tune code among a plurality of tune code candidates to the antenna impedance tuner circuit based on the circuit characteristic value; and
calculate an output reflection coefficient with respect to the antenna based on the input reflection coefficient and the first S parameter.

3. The impedance tuning system of claim 2, wherein the tuner control circuit is configured to obtain an S parameter corresponding to each of the plurality of tune code candidates according to the application of each of the plurality of tune code candidates to the antenna impedance tuner circuit, and calculate power loss cost with respect to each of the plurality of tune code candidates based on the S parameter corresponding to each of the plurality of tune code candidates and the output reflection coefficient.

4. The impedance tuning system of claim 3, wherein the tuner control circuit is configured to calculate a power loss cost with respect to each of the plurality of tune code candidates by using at least one of a voltage standing wave ratio (VSWR) method and a relative transducer gain (RTG) method.

5. The impedance tuning system of claim 1, wherein the tuner control circuit is configured to determine the optimal tune code by using a hill-climbing algorithm.

6. The impedance tuning system of claim 1, wherein:
the circuit characteristic value further comprises an impedance value of a transmission line included in each of the plurality of stages; and
the tuner control circuit is configured to determine the optimal tune code further based on antenna impedance tuning (AIT) data indicating characteristics with respect to each of the plurality of stages.

7. The impedance tuning system of claim 6, wherein the AIT data comprises at least one of: data indicating a circuit type of each of the plurality of stages; data indicating a coefficient of each of the plurality of stages; data indicating a number of control bits of each of the plurality of stages; and data indicating a bypass code of each of the plurality of stages.

8. A driving method of an impedance tuning system, comprising:
receiving an input reflection coefficient generated based on a coupled signal received from a bi-directional coupler;
calculating an output reflection coefficient with respect to an antenna based on a circuit characteristic value which is calculated based on an impedance value of a passive element comprised in each of a plurality of stages of an antenna impedance tuner circuit connected between the bi-directional coupler and an antenna, and the input reflection coefficient;
determining an optimal tune code to correspond to the output reflection coefficient and the input reflection coefficient; and
controlling the antenna impedance tuner circuit based on the optimal tune code.

9. The driving method of claim 8, wherein the calculating the output reflection coefficient comprises:
calculating a first S parameter of the antenna impedance tuner circuit according to an application of a first candidate tune code among a plurality of tune code candidates to the antenna impedance tuner circuit based on the circuit characteristic value; and
calculating the output reflection coefficient based on the input reflection coefficient and the first S parameter.

10. The driving method of claim 9, wherein the determining the optimal tune code comprises:
calculating an S parameter corresponding to each of the plurality of tune code candidates according to an application of each of the plurality of tune code candidates to the antenna impedance tuner circuit, and calculating a power loss cost with respect to each of the plurality of tune code candidates based on the S parameter corresponding to each of the plurality of tune code candidates and the output reflection coefficient; and
determining a tune code candidate having an optimal power loss cost among the plurality of tune code candidates as the optimal tune code with respect to the input reflection coefficient based on power loss costs with respect to each of the plurality of tune code candidates.

11. The driving method of claim 10, wherein the calculating the power loss cost comprises calculating the power loss cost by using at least one method among a voltage standing wave ratio (VSWR) method and a relative transducer gain (RTG) method.

12. The driving method of claim 10, wherein the determining the optimal tune code comprises determining the optimal tune code by using a hill-climbing method.

13. A driving method of a impedance tuning system, comprising:
dividing an antenna impedance tuner circuit connected between an antenna and a bi-directional coupler into a plurality of stages;
obtaining antenna impedance tuning (AIT) data indicating characteristics with respect to each of the plurality of stages;
calculating a circuit characteristic value comprising an impedance value of a passive element of the AIT data included in each of the plurality of stages; and
storing the circuit characteristic value for use in real time impedance tuning of the antenna impedance tuner circuit.

14. The driving method of claim 13, wherein the dividing the antenna impedance tuner circuit into the plurality of stages comprises dividing the plurality of stages based on a shunt switch of the antenna impedance tuner circuit.

15. The driving method of claim 13, wherein the calculating the circuit characteristic value comprises:
modelling each of the plurality of stages as a circuit having a corresponding passive element and a corresponding transmission line based on the AIT data;
determining a first stage comprising a first passive element, a first switch, and a first transmission line and being adjacent to the antenna among the plurality of stages as a target stage;
determining at least one remaining stage excluding the target stage among the plurality of stages as a first passive black box (PBB); and
calculating a characteristic value of the first passive element and a characteristic value of the first transmission line.

16. The driving method of claim 15, wherein the calculating the characteristic value comprises:
measuring a first measured reflection coefficient PBB_{tc,on} when the antenna is viewed from the antenna impedance tuner circuit in a case that the first switch is turned-on; and
measuring a second measured reflection coefficient PBB_{to,off} when the antenna is viewed from the antenna impedance tuner circuit in the case that the first switch is turned-off.

17. The driving method of claim 16, wherein:
the AIT data comprises at least one of: data indicating a circuit type of each of the plurality of stages, data indicating the coefficient of each of the plurality of stages, data indicating a number of control bits of each of the plurality of stages, and data indicating a bypass code of each of the plurality of stages;
an ABCD parameter of the first transmission line is
$$( \begin{matrix}{A}_{TL} & {Z}_{0} {b}_{TL} \\ {Y}_{0} {c}_{TL} & {D}_{TL}\end{matrix} ) ;$$
and
the ABCD parameter of the first PBB is
$$( \begin{matrix}{A}_{tc} & {B}_{tc} \\ {C}_{tc} & {D}_{tc}\end{matrix} ) .$$

18. The driving method of claim 17, wherein, when the target stage is a series type based on the AIT data:
the ABCD parameter of the first passive element is
$$( \begin{matrix}1 & Z \\ 0 & 1\end{matrix} ) ;$$
the characteristic value of the first passive element is
$$Z = {Z}_{0}^{2} {C}_{tc}^{′} + {B}_{tc}^{′} = {ZA}_{TL}^{2} - {Zb}_{TL}^{2} ,$$
where Z₀ is a reference impedance value; and
the characteristic value of the first transmission line is
$$T L = \frac{( \frac{{A}_{tc}^{′} - {D}_{tc}^{′}}{z} ) + ( {B}_{tc}^{′} - {Z}_{0}^{2} {C}_{tc}^{′} )}{z} , where , ( \begin{matrix}{A}_{tc}^{′} & {B}_{tc}^{′} \\ {C}_{tc}^{′} & {D}_{tc}^{′}\end{matrix} ) ≅ {PBB}_{tc , on}^{- 1} {PBB}_{tc , off} .$$

19. The driving method of claim 17, wherein, when the target stage is a shunt type based on the AIT data:
the ABCD parameter of the first passive element is
$$( \begin{matrix}1 & 0 \\ Y & 1\end{matrix} ) ;$$
the characteristic value of the first passive element is
$$Y = {C}_{tc}^{′} + \frac{{B}_{tc}^{′}}{{z}_{0}^{2}} = {A}_{TL}^{2} Y - {b}_{TL}^{2} Y ,$$
where Z₀ is a reference impedance value; and
the characteristic value of the first transmission line is
$$T L = \frac{( \frac{{A}_{tc}^{′} - {D}_{tc}^{′}}{z} ) + ( {C}_{tc}^{′} - \frac{{B}_{tc}^{′}}{{z}_{0}^{2}} )}{Y} , where , ( \begin{matrix}{A}_{tc}^{′} & {B}_{tc}^{′} \\ {C}_{tc}^{′} & {D}_{tc}^{′}\end{matrix} ) ≅ {PBB}_{tc , on}^{- 1} {PBB}_{tc , off} .$$

20. The driving method of claim 15, further comprising:
determining whether the characteristic value has been calculated with respect to each of the plurality of stages;
generating a first antenna equivalent model by reflecting a device characteristic value of the target stage; and
determining the first antenna equivalent model as representative of the antenna.
